(19) United States
(12) Patent Application Publication
(10) Pub. No.: US 2010/0237101 A1
(43) Pub. Date: Sep. 23, 2010

(54) Cleaning Mechanism of build-up for the dispenser

(76) Inventors: John Tanak, Davis, CA (US); Hob Iwasa, Davis, CA (US)

Correspondence Address: Tanak & Associates, PO Box 4327, Davis, CA, 95617, US

(21) Appl. No.: 12/405,262

(22) Filed: Mar. 17, 2009

(51) Int. Cl. B67D 1/08

(52) U.S. Cl. 222/149; 222/151

(57) ABSTRACT

In dispensing the high viscosity fluids, there used to be a inconvenience, due to the build-up growth around the throat of the container during it's usage. The upright piece(s) build in (or attached on) the closure of present invention separates out the build-up from the container throat by turning/twisting the closure. It fresh opens the throat.

### BACKGROUND OF INVENTION

Present invention generally relates to the closure for the dispenser of fluids and materials, specifically the cleaning mechanism of the build-up built in (or attached on) the closure for high viscosity fluids and materials (such as viscous chemicals (for example, cleanser, paste) foods (for example, ketchup, mustard, mayonnaise, shortening), etc.)

In dispensing the high viscosity fluids and materials which are mentioned in the above, there used to be a inconvenience, due to the build-up growth around the throat of the container during it's usage.

When the dispenser employs the flow reduction method of orifice type, a build-up tends to significantly block the flow of fluids and materials.

There is a different type of dispenser (for high viscosity fluids and materials) in the market, It employs valve on the bottom of the container. One of examples is SoftScrub.

It provides the user with initially quicker dispensing. But it does not suction the air well for the next pumping, even when substantial amount of contents is remaining in the container.

### SUMMARY OF THE INVENTION

The closure made by employing the cleaning mechanism of the present invention provides the user of the dispenser with easy cleaning the build-up which is blocking the flow of fluids and materials at the throat of the dispenser. The piece(s) (or block(s)) built in (or attached on) the closure of present invention separates the build-up of the fluids and materials (located at the throat of the container) from the throat of the container, when the user turns (or twists) the closure. Therefore it fresh opens the throat of the container, resulting in allowing enough flow of fluids and materials easily and repeatedly.

The closure which employs the present invention, suctions the air well from the top side of the container, for the next pumping. It pumps out the fluids and materials well repeatedly, although it may takes initially longer time for the fluid and materials to move down to the mouth of the container.

The present invention also provides the designer of the dispenser, with more flexibility and freedom in design than the bottom valve type dispenser does. For example, To add elegance in design.

In order to make the stable dispenser (in view of gravity force), the dispenser which employs valve on the bottom of the container is not very stable on the shelf and also requires larger closure on the bottom of the dispenser. The larger closure requires more materials and more cost to make.

On the other hand, the closure which employs present invention, requires less materials and less cost to make.

The present invention can be made economically by (but not limited to) plastic.

When the piece(s) or block(s) of present invention is made separately from the closure itself, the piece(s) (or block(s)) of the present invention can be easily attached to the closure by the user after the user bought the product.

(This saves the manufacturer's production cost)

### BRIEF DESCRIPTION OF THE DRAWINGS

FIG. 1: Dispenser system with cleaning mechanism

FIG. 2. A cleaning mechanism built on the closure and build-up in the container

FIG. 3: Case examples of the cleaning mechanism

FIG. 3: Case examples of the cleaning mechanism

FIG. 4-1: Case examples of the cleaning mechanism

FIG. 4-2: Case examples of the cleaning mechanism

FIG. 5: Case examples of the cleaning mechanism

FIG. 6: Case examples of the cleaning mechanism, showing the manner of contact

FIG. 7: Case examples of the cleaning mechanism, showing the manner of contact

FIG. 8: Case examples of the cleaning mechanism, showing the manner of contact

FIG. 9: Case examples of the cleaning mechanism, showing the manner of contact

FIG. 10: Case examples of the cleaning mechanism, showing the manner of contact

### DESCRIPTION OF THE PREFERRED EMBODIMENT

The embodiment shall be made of plastic, metal, wood, other solid (or soft solid) state materials.

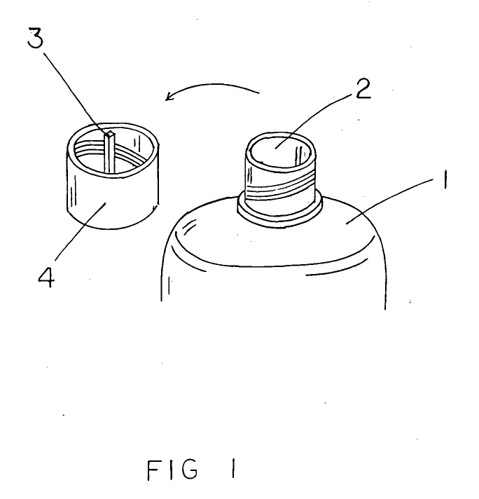

FIG. 1 is the schematic view of a opened closure and container. 1 is the container. 2 is the throat of the container. 3 is the piece of cleaning mechanism of present invention. 4 is the closure.

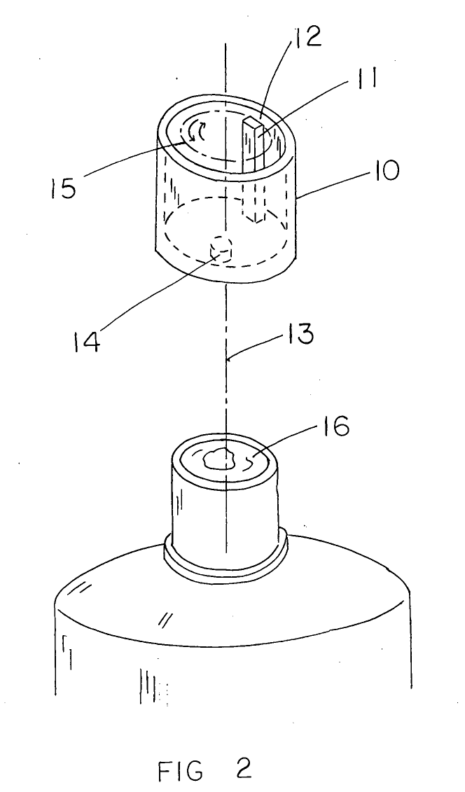

FIG. 2 is the schematic view of the closure (in bottom side top), having piece of cleaning mechanism and the container, having build up growth.

Screws on the outside of container throat and inside of closure are not shown to avoid complexity.

10 is the closure.

11 is the piece of cleaning mechanism of present invention.

12 is the space for the throat of the container. 13 is the center axis of the closure. 14 is the hole of orifice (example).

15 is the path of the piece of cleaning mechanism, when the user turns (twists) the closure.

16 is the container throat on which build-up has grown. When the build up of fluid and material has grown on the throat of the container, the user turns (or twists) the closure as the manner arrow indicates. Then the build up will separates from the throat of the container.

In the followings, a line (including non-straight line) is defined as the manner having the width less than (equals to) 5% of the length.

A about-line (including a wide line and non-straight wide line) is defined as the manner having the width more than 5% and less than (equals to) 40% of the length. A area is defined as the manner having the width more than 40% of the length.

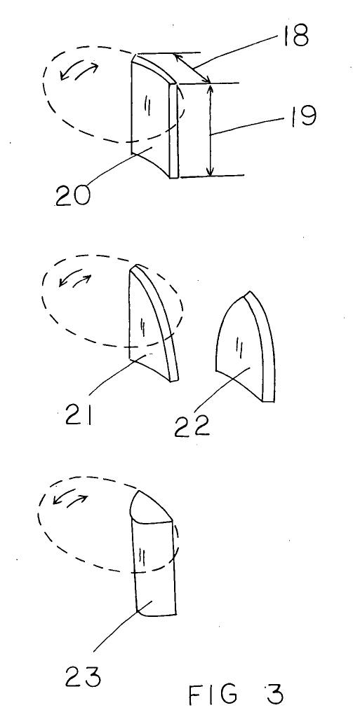

A typical width and a length of a piece are shown as 18 and 19 respectively in 20 of FIG. 3.

FIG. 3 (shown in bottom side top) is the case examples of the pieces, having a area contact (or almost contact) with the inner surface of the throat of the container.

20 is a flat piece having a rectangular area.

21, 22 are a flat pieces having a triangular area.

23 is a non flat piece having a rectangular area.

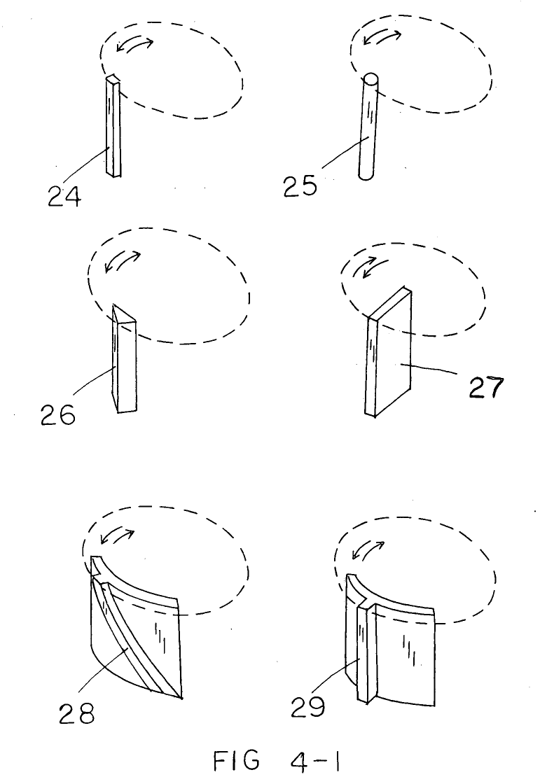

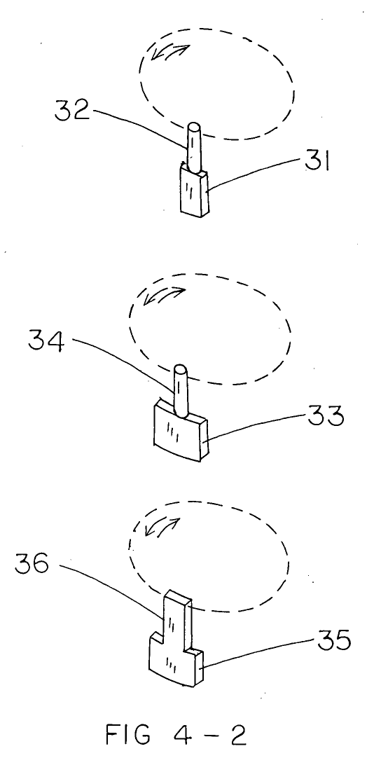

FIG. 4-1 (shown in bottom side top) is the case examples of the pieces having a line (or a about-line) contact (or almost contact) with the inner surface of the throat of the container.

24 is a piece having a straight wide line.

25 is a thin piece having a straight line. 26 is a piece having a straight line. (non rectangle, non circular cross sections)

27 is a thick piece having a straight wide line.

28 is a piece having a sloped wide line built on the block. 29 is a piece having a straight wide line built on the block.

FIG. 4-2 (shown bottom side top) is the case examples of the pieces having the combination of a line and a about-line or the combination of a line and a area or the combination of a about-line and a area, which contacts (or almost contact) with the inner surface of the throat of the container.

1st (from the top) example is the piece, having the combination of a line (32) and a about-line (31).

2nd (from the top) example is the piece, having the combination of a line (34) and a area (33).

3rd (from the top) example is the piece, having the combination of a about-line (36) and a area (35).

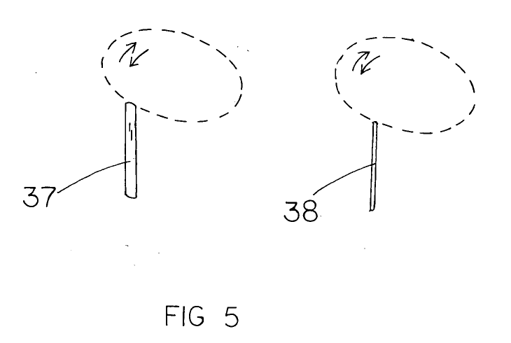

FIG. 5 (shown in bottom side top) is the case examples of the pieces having a line contact (or almost contact) with the inner surface of the throat of the container.

37 is a very thin piece having a wide line (for example being made of steel). 38 is a very thin piece having a line (for example being made of steel).

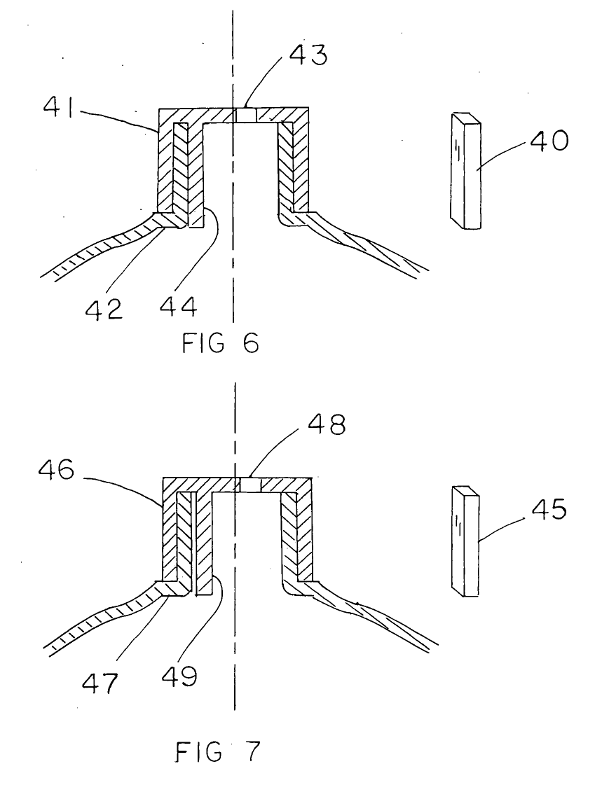

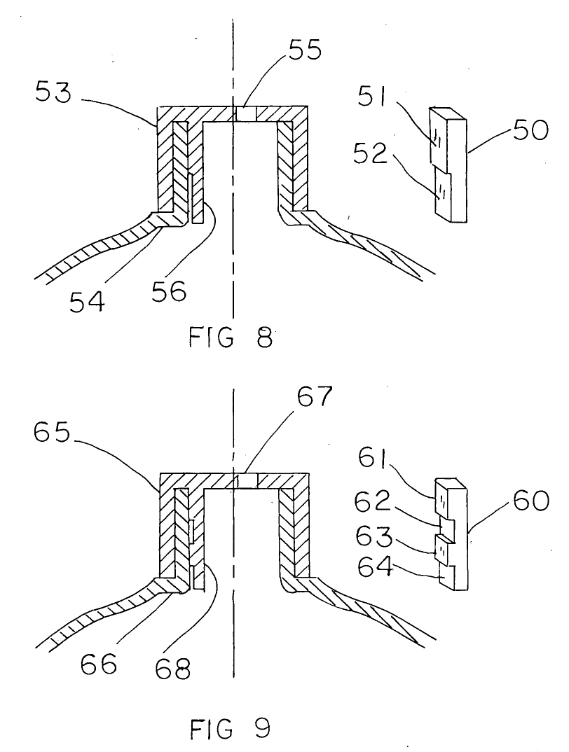

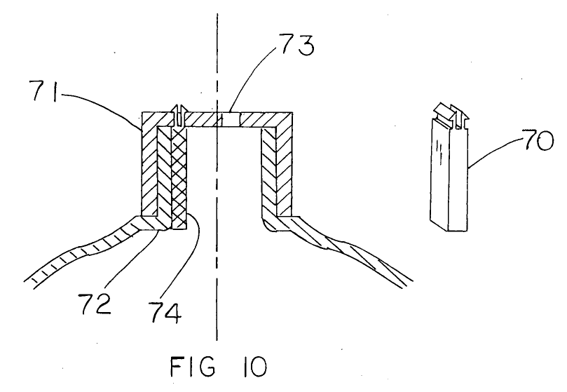

FIG. 6, FIG. 7, FIG. 8, FIG. 9 are the case examples of the designs of the pieces having different shapes in view of how pieces contact with the inner surface of the throat of the container.

Screws on outside of the container throat and inside of the closure are not shown in order to avoid complexity.

FIG. 6 is the schematic view of the cleaning mechanism and it's piece having a wide line which contacts with the inner surface of the throat of the container. 40 is the piece having a wide line. 41 is the closure. 42 is the container. 43 is the hole of orifice. 44 is the piece which contacts with the inner surface of the throat of container.

FIG. 7 is the schematic view of the cleaning mechanism and it's piece having a wide line which almost contacts with the inner surface of the throat of the container. 45 is the piece having a wide line. 46 is the closure. 47 is the container. 48 is the hole of orifice. 49 is the piece which almost contacts with the inner surface of the throat of container.

FIG. 8 is the schematic view of the cleaning mechanism and it's piece having a wide line which in part contacts and in part almost contact with the inner surface of the throat of the container. 50 is the piece having a wide line A (51) which contacts and a wide line B (52) which almost contacts with the inner surface of the throat of the container.

53 is the closure. 54 is the container. 55 is the hole of orifice. 56 is the piece which in part contacts and in part almost contacts with the inner surface of the throat of container.

FIG. 9 is the schematic view of the cleaning mechanism and it's piece having a wide line which in part contacts and in part almost contacts with the inner surface of the throat of the container. 60 is the piece having wide lines A (61,63) which contact with and wide lines B (62,64) which almost contacts with the inner surface of the throat of the container.

65 is the closure. 66 is the container. 67 is the hole of orifice. 68 is the piece which in part contacts and in part almost contacts with the inner surface of the throat of container mentioned in 60.

FIG. 10 is the case example of the cleaning mechanism (having a line) which is made as a separate piece from the closure and then attached to the closure.

70 is the piece having a wide line. 71 is the closure.

72 is the container. 73 is the hole of orifice.

74 is the piece which is made as a separate piece and then attached to the closure.

It should be evident that the above cases are by way of examples of cleaning mechanism and that various different types of cleaning pieces (or blocks) may be made as long as they do not substantially block the flow of the fluids, materials.

It is also evident that the closure, employing the said mechanism may be combined with hinge-cap (for example). But it is not limited to hinge-cap.

1. A cleaning mechanism means:
1.1 being made of plastic, metal, wood, other solid (or soft solid) state material;
1.2 comprising one (or more than one of) upright piece (or block), or piece (or block) built on the upright piece (or upright block) which is built in (or made as a separate item from the closure and then attached to) the closure;
1.3 having a area or a line or a about-line or a combination of a line and a about-line or a combination of a about-line and a area or a combination of a area and a line and a about-line, which contacts with the inside wall of the throat of the container in order to perform the function described in the claim 1.4,
wherein the said area or the said line or the said about-line or the said combination of a line and a about-line or the said combination of a about-line and a area or the said combination of a area and a line and a about-line, being long enough to cover the depth of the container's throat on which the build-up has grown in order to perform the function described in the claim 1.4
1.4 being capable of separating the build-up from the throat of container, when user turns (or twists) the closure.

2. A cleaning mechanism means:
2.1 being made of plastic, metal, wood, other solid (or soft solid) state material;
2.2 comprising one (or more than one of) upright piece (or block), or piece (or block) built on the upright piece (or the upright block) which is built in (or made as a separate item from the closure and then attached to) the closure in order to perform the function described in the claim 2.4
2.3 having a area or a line or a about-line or a combination of a line and a about-line or a combination of a about-line and a area or a combination of a area and a line and a about-line, which almost contacts with the inside wall of the throat of container,
wherein the said area or the said line or the said about-line or
the said combination of a line and a about-line or the said combination of a about-line and a area or the said combination of a area and a line and a about-line, being long enough to cover the depth of the container's throat on which the build-up has grown and falling short to contact with the inside wall of the throat of the container and being located near the inside wall of the throat of container to reach the most of the build-up in a manner that the path of the upright piece (or block) or of the piece (or block) built on the upright piece (or block) keeps the most of the build-up inside of the path (i.e. in center axis side), when user turns (or twists) the closure in order to perform the function described in claim 2.4;
2.4 being capable of separating the build-up from the throat of container, when user turns (or twists) the closure.

3. A cleaning mechanism means:
3.1 being made of plastic, metal, wood, other solid (or soft solid) state material;
3.2 comprising one (or more than one of) upright piece (or block), or the piece (or the block) built on the upright piece (or the upright block) which is built in (or made as a separate item from closure and then attached to) the closure;
3.3 having in part a area A or a line A or a about-line A or a combination A of a line and a about-line or a combination A of a about-line and a area or a combination A of a area and a line and a about-line, which contacts with the inside wall of the throat of the container in order to perform the function described in the claim 3.6;
3.4 having in part a area B or a line B or a about-line B or a combination B of a line and a about-line or a combination B of a about-line and a area or a combination B of a area and a line and a about-line, which almost contacts with inside wall of the throat of the container,
wherein the said area B or the said line B or the said about-line B or the said combination B of a line and a about-line or the said combination B of a about-line and a area or the said combination B of a area and a line and a about-line, falling short to contact with the inside wall of the throat of the container and being located near the inside wall of the throat of the container to reach the most of the build-up in a manner that the path of the upright piece (or block) or of the piece (or block) built on the upright piece (or block) keeps the most of the build-up inside of the path (i.e. in center axis side), when user turns (or twists) the closure in order to perform the function described in the claim 3.6;
3.5 having the total length which comprises 1st length and 2nd, length the said total length being long enough to cover the depth of the container's throat on which build-up has grown in order to perform the function described in the claim 3.6,
wherein the said 1st length is the length of the said area A or the said line A or the said about line A or the said combination A of a line and a about-line or the said combination A of a about-line and a area or the said combination A of a area and a line and a about-line and
the said 2nd length is the length of the said area B or the said line B or the said about-line B or the said combination B of a line and a about-line or the said combination B of a about-line and a area or the said combination B of a area and a line and a about-line;
3.6 being capable of separating the build-up from the throat of container, when user turns (or twists) the closure.
